(19) United States
(12) Patent Application Publication
(10) Pub. No.: US 2014/0189235 A1
(43) Pub. Date: Jul. 3, 2014

(54) STEALTH APPLIANCE BETWEEN A STORAGE CONTROLLER AND A DISK ARRAY

(71) Applicant: Eric Obligacion, Malvem, PA (US)

(72) Inventor: Eric Obligacion, Malvem, PA (US)

(73) Assignee: Unisys Corporation, Blue Bell, PA (US)

(21) Appl. No.: 13/731,217

(22) Filed: Dec. 31, 2012

(51) Int. Cl. G06F 12/14; G06F 3/06

(52) U.S. Cl. CPC G06F 12/1408; G06F 3/0689; G06F 3/0619; G06F 3/0655
USPC 711/114; 711/164

(57) ABSTRACT

A stealth appliance may be coupled between a storage controller and a disk array. The stealth appliance may be configured to receive a request from the storage controller encrypted with a first community-of-interest (COI) key, to decrypt the request with the first COI key, to encrypt the request with a second COI key, and to transmit the encrypted request to the disk array.

### FIELD OF DISCLOSURE

The instant disclosure relates to computer networks. More specifically, this disclosure relates to securing data on a network.

### BACKGROUND

Virtual machines running in a cloud are not well protected from other machines in the cloud, or from devices with physical access to the cloud. For example, virtual machines executing in a cloud may receive communications from any device in the cloud. Further, data transmitted by the virtual machine in the cloud may be intercepted by unintended recipients.

In a conventional solution, a network may include a plurality of servers hosting virtual machines leased by tenants. The virtual machines may start and stop based on demand for the tenant's services. Because the virtual machines are frequently starting and stopping there are no dedicated resources for the tenant. This reduces the cost for the tenant, because resources are only used when they are needed. Thus, the tenant only pays for resources as they are used. However, because there is no leased hardware for the tenant, the tenant's virtual machines may start on any one of a number of server systems in the network.

For example, a tenant may be a customer owning one or more virtual machines executing within the network. Because the virtual machines execute on shared hardware with other virtual machines belonging to other tenants, the transmission to and/or from the virtual machine may be intercepted by another tenant. Conventional solutions for isolating hardware of one tenant from hardware of another tenant are not useful for improving security, because any tenant's virtual machine may execute on hardware with another tenant's virtual machines.

### SUMMARY

Cryptography may be used protect communication between virtual machines. Each virtual machine may be configured to be members of one or more communities-of-interest (COI). When an attempt is made to initiate communication between virtual machines, a common COI may be identified. Communication may be performed by encrypting messages when sent and decrypting them on receipt using a cryptographic key possessed only by virtual machines of the COI. Non-members of the COI may be unable to view the message, despite sharing hardware or access to a network. In addition to organizing virtual machines into communities-of-interest, virtual machines may be organized into enclaves separated from other virtual machines by a virtual gateway. The virtual gateway may isolate the virtual machines in the enclave by controlling access between those virtual machines and the network outside the enclave, Within the enclave, transmission between virtual machines may be encrypted, and the virtual gateway may act as a gateway to unencrypted networks. Dynamic licensing may be implemented within the enclaves to allow virtual machines to obtain dynamic licenses through the virtual gateway. Thus, licenses for the virtual machines may move between virtual machines as the virtual machines are stopped and started. Further, the virtual machines within an enclave may be configured and/or provisioned automatically for encrypted communications.

According to one embodiment, a system includes a storage controller on a first secured network, a disk array on a second secured network, and a stealth appliance coupled. to the storage controller and the disk array.

According to another embodiment, a method includes receiving, by a stealth appliance, a request from the storage controller encrypted with a first community-of-interest (COI) key. The method also includes decrypting, by the stealth appliance, the request with the first COI key. The method further includes encrypting, by the stealth appliance, the request with a second COI key. The method also includes transmitting, by the stealth appliance, the encrypted request to the disk array.

According to a further embodiment, an apparatus includes a memory, a network interface, and a processor coupled to the memory and to the network interface. The processor is configured to receive, through the network interface, a request from the storage controller encrypted with a first community-of-interest (COI) key. The processor is also configured to decrypt, by the processor, the request with the first COI key. The processor is further configured to encrypt, by the processor, the request with a second COI key. The processor is also configured to transmit, through the network interface, the encrypted request to the disk array.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a. method for cryptographically isolating virtual machines according to one embodiment of the disclosure.

FIG. 2 is a. block diagram illustrating an encrypted enclave of virtual machines organized into communities-of-interest according to one embodiment of the disclosure.

FIG. 3 is a block diagram illustrating a network implementing community-of-interests according to one embodiment of the disclosure.

FIG. 4 is a block diagram illustrating a network configured for stealth having a stealth controller between a storage server and a disk array according to one embodiment of the disclosure.

FIG. 5 is a flow chart illustrating a method of facilitating communication between a storage controller and a disk array located on different networks according to one embodiment of the disclosure.

FIG. 6 is a block diagram illustrating a computer network according to one embodiment of the disclosure.

FIG. 7 is a block diagram illustrating a computer system according to one embodiment of the disclosure.

FIG. 8A is a block diagram illustrating a server hosting an emulated software environment for virtualization according to one embodiment of the disclosure.

FIG. 8B is a block diagram illustrating a server hosting an emulated hardware environment according to one embodiment of the disclosure.

### DETAILED DESCRIPTION

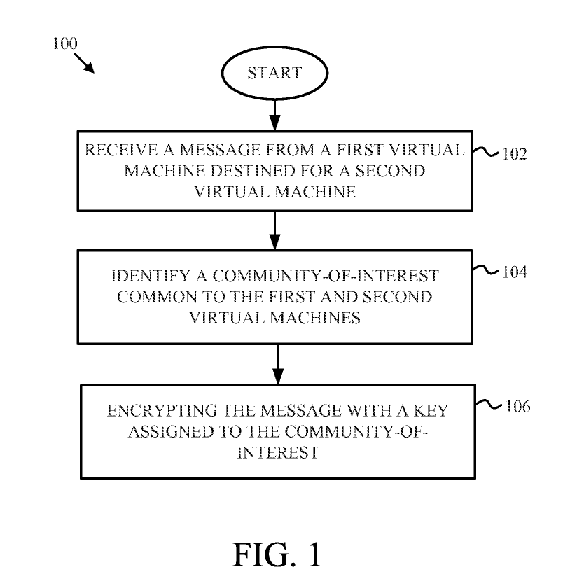

FIG. 1 is a flow chart illustrating a method for cryptographically isolating virtual machines according to one embodiment of the disclosure. A method 100 begins at block 102 with receiving a. message from a first virtual machine destined for a second virtual machine.

The second virtual machine may be hosted by the same server or a different server from the first virtual machine. The message may include information, such as application-layer data. The message may be formatted as packetized data according to, for example, a transmission control protocol/internet protocol (TCP/IP).

At block 104, a common community-of-interest is identified between the first and the second virtual machines. Virtual machines executing on one or more servers may each be assigned one or more communities-of-interest (COI). The communities-of-interest may allow an administrator to create logical organizations of virtual machines. A community-of-interest may be defined by a role of the virtual machines in the COI. For example, an administrative COI may be created for virtual machines handling administrative tasks. A community-of-interest may also be defined by the capabilities of the virtual machines in the COI. For example, a high-performance COI may be created for virtual machines having more than one processor available for calculations. The communities-of-interest may further be used to separate communications between virtual machines, even when the virtual machines of different communities-of-interest share a physical network connection and/or physical hardware.

A first virtual machine may identify whether the second virtual machine is a member of at least one community-of-interest with the first virtual machine by consulting a look-up table and/or querying the second virtual machine. When tine first and the second virtual machine share several communities-of-interest, a priority scheme may be used to select a particular one of the communities-of-interest for transmitting the message. For example, a client community-of-interest group may be preferred over an administrative community-of-interest group. Further, a community-of-interest may also be prioritized based on other members of the community-of-interest, such as when the first virtual machine does not desire certain virtual machines other than the second virtual machine to be able to receive the message. For example, when multiple communities-of-interest are shared between the first and the second virtual machine, the community-of-interest with the least number of members may be prioritized for communications to limit potential eavesdroppers.

At block 106, the message is encrypted with a key corresponding to the community-of-interest. A session key may be created for transmitting the message from the first virtual machine to the second virtual machine. The session key may be encrypted with a key corresponding to the community-of-interest and transmitted from the first virtual machine to the second virtual machine. Only other virtual machines that are a member of the community-of-interest may decode the session key. The message received at block 102 may be transmitted with this session key, which may be only known to the second virtual machine. Thus, communications between the first and the second virtual machine may be cryptographically isolated from other virtual machines, particularly virtual machines owned by other tenants in the network. The encryption keys for the communities-of-interest may be installed from a secure boot device, such as disclosed in related U.S. patent application No. ______, which is hereby incorporated by reference.

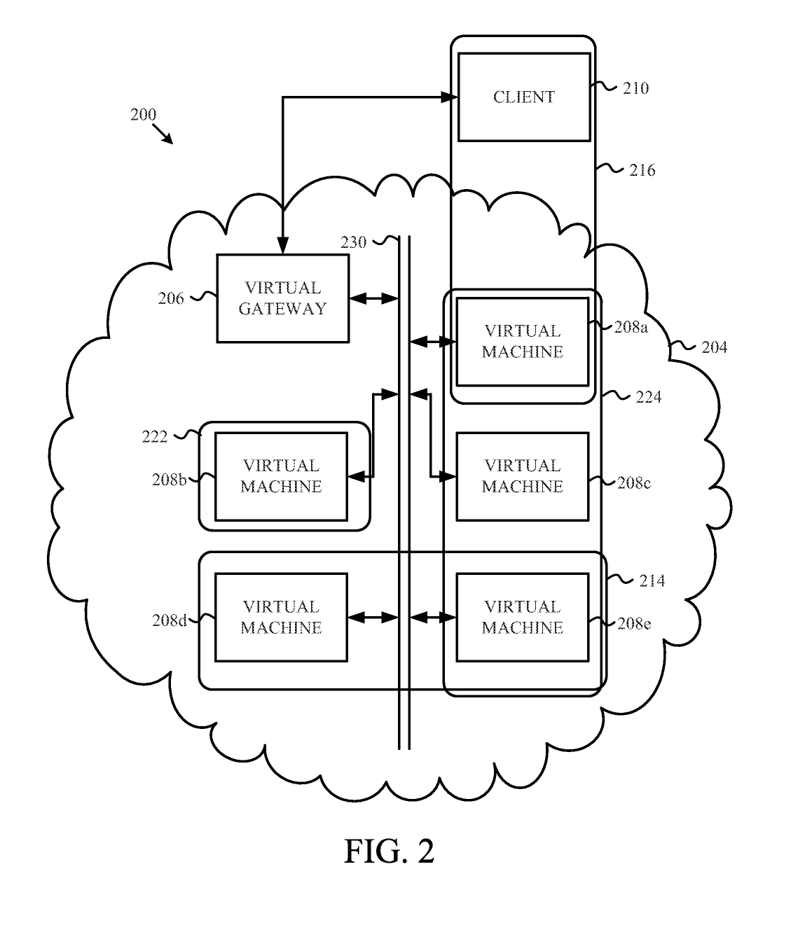

FIG. 2 is a block diagram illustrating an encrypted enclave of virtual machines organized into communities-of-interest according to one embodiment of the disclosure. A network 200 may include a network bus 230 serving an enclave 204. The bus 230 may couple virtual machines 208a-e within the enclave 204, Each of the virtual machines 208a-e may communicate through encrypted communications carried on the bus 230. Further, the bus 230 may be private to prevent access by unwanted guests. A virtual gateway 206 may be coupled to the bus 230 to provide communications from the enclave 204 to external devices, such as the client 210 and/or other public networks, such as the Internet. The client 210 may be a remote device, such as a personal computer or a mobile device. The client 210 may be connected to the virtual gateway 206 through a secured tunnel, such that communications between the client 210 and the virtual gateway 206 are encrypted similar to the encrypted communications on the bus 230. The client 210 may also be connected to the virtual gateway 206 through an unencrypted communications link, in which the communications with the client 210 are encrypted by the virtual gateway 206 for transmission on the bus 230 and communications from the bus 230 are decrypted for transmission to the client 210.

The virtual machines 208a-e may be assigned to one or more communities-of-interest (COI). For example, the virtual machines 208a, 208c, and 208e may be assigned to COI 224. In another example, the virtual machines 208d and 208e may be assigned to COI 214, Communities-of-interest may also include only a single virtual machine, such as when other virtual machines assigned to the COI have been stopped. For example, COI 222 may include the virtual machine 208b. Further, communities-of-interest may also include devices located outside of the enclave 204. For example, COI 216 may include the virtual machine 208a and the client 210.

A virtual machine 208e may be instructed to transmit a message to the virtual machine 208a. For example, software executing on the virtual machine 208e may request data from a database server executing on the virtual machine 208a. When the virtual machine 208e receives the message destined for the virtual machine 208a, the virtual machine 208e, or a device hosting the virtual machine 208e, may identify a community-of-interest in common between the virtual machine 208e and the virtual machine 208a. The COI 224 may be identified as a community-of-interest shared between the virtual machine 208e and the virtual machine 208a. Thus, a key corresponding to the COI 224 may be used to encrypt the message, which is then transmitted to the virtual machine 208a. The key may be a session key previously transmitted to the virtual machine 208a, after being generated by the virtual machine 208e and encrypted with a key for the COI 224.

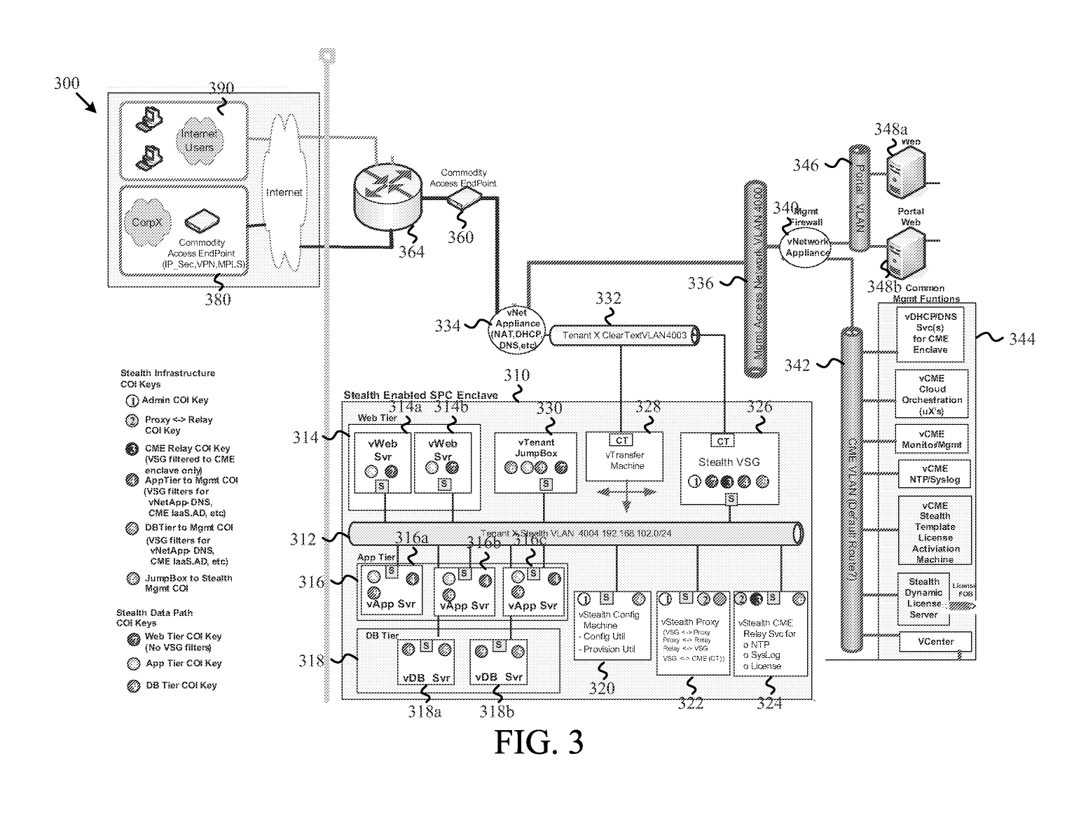

The community-of-interest organization of virtual machines may be implemented in a computer network to provide cryptographic isolation of virtual machines. FIG. 3 is a block diagram illustrating a network implementing community-of-interests according to one embodiment of the disclosure. A network 300 may include an enclave 310. According to one embodiment, the enclave 310 may belong to a single tenant of the network 300. In other embodiments, the enclave 310 may be shared between tenants.

Communities-of-interests may be configured for a web tier 314, an application tier 316, and a database tier 318. The web tier 314 may include a number of web servers 314a-b, the application tier 316 may include a number of application servers 316a-c, and the database tier 318 may include a number of database servers 318a-b. Each of the servers 314a-b, 316a-c, and 318a-b may be a virtual server executing within a virtual machine. Additional communities-of-interest may be defined for infrastructure functions, such as an administrator community-of-interest key COI, a relay COI, an application tier management COI, a database tier management COI, and a jumpbox management COI. The enclave 310 may also include a jumpbox 330, a transfer machine 328, a virtual gateway 326, a relay 324, a proxy 322, and a configuration device 320, which may also be executing in virtual machines.

Membership of the virtual machines of FIG. 3 in individual COIs are shown as numbered circles. Each circle may represent a different COI, such as the web tier COI. For example, a web tier COI may include the servers 314a-b, the jumpbox 330, and the virtual gateway 326. According to one embodiment, only virtual machines that share a. common COI may communicate. When a first virtual machine initiates communication with a second virtual machine, the first virtual machine may search for a common COI between the first and the second virtual machine. If found, a. cryptographic session key may be created that is encrypted with a key associated with the common COI. Thus, only a virtual machine that shares the COI key may decrypt the session key. All communication between the two virtual machines may be encrypted and decrypted with the session key. Messages within the enclave 310 may be isolated from the rest of the network 300, because the messages are encrypted with keys that are not available to the rest of the network 300.

For example, a web server virtual machine 314a may be able to communicate with another web server virtual machine 314b, because the virtual machines 314a-b have the web tier COI in common. They may also be able to communicate with application server virtual machines 316a-c, because the machines 314a-b and 316a-c have the application tier COI in common.

Each of the devices within the enclave 310 may be coupled to a bus 312. When a device within the enclave 310 communicates with devices outside the enclave 310, then messages may be handled by the virtual gateway 326, which may be coupled to an unencrypted. network 332. According to one embodiment, theyirtual gateway 326 may encrypt and/or decrypt messages between the enclave 310 and the unencrypted network 332. The network 332 may couple the enclave 310 to other network appliances 334, such as network address translation (NAT) devices, dynamic host control protocol (DHCP) devices, domain name service (DNS) devices, and the like. The other network appliances 334 may also be executing in virtual machines.

Access to the enclave 310 may be controlled by the virtual gateway 326. Messages passing through the gateway 326 from the unencrypted, or clear-text, network 322 to the enclave 310 may be encrypted and messages in the other direction may be decrypted by the gateway 326. According to one embodiment, messages within the enclave 310 may only be transmitted to a virtual machine that has a COI in common with the gateway 326. Furthermore, the gateway 326 may be configured to filter messages for a COI. The filter may allow an administrator to restrict access based on a message's source and/or destination address and/or port. The enclave 310 may also be isolated from other enclaves (not shown) in the network 300, because only a virtual machine having a common COI with the gateway 326 may communicate outside of the enclave 310.

For example, the web servers 314a-b may be able to communicate through the gateway 326, because the web servers 314a-b share the web tier COI with the gateway 326. In another example, the application servers 316a-c and the database servers 318a-b may have restricted access through the gateway 326, because the gateway 326 may filter messages transmitted in the application COI and the database CO1 to only provide access to management devices 344.

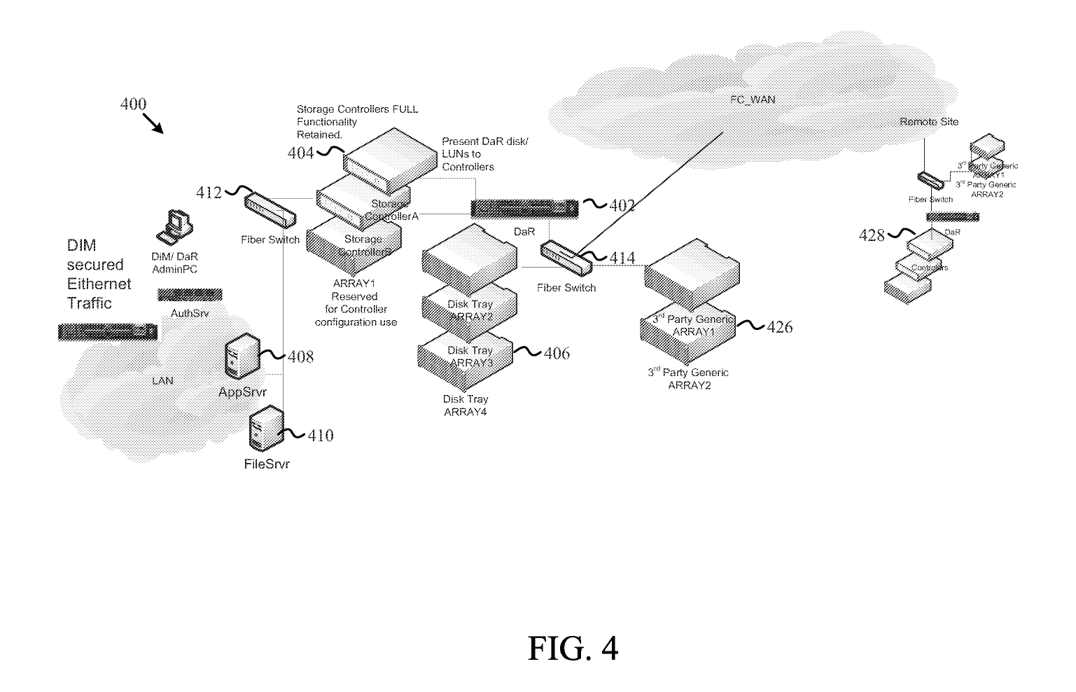

FIG. 4 is a block diagram illustrating a network configured for stealth having a stealth controller between a storage server and a disk array according to one embodiment of the disclosure. A system 400 includes a stealth controller 402 coupled between storage controllers 404 and a disk array 406. The storage controllers 404 may receive requests for data from an application server 408 or a file server 410 connected to the storage controller 404 through a switch 412. The servers 408 and 410 may be serving data on a secured Ethernet network. The storage controllers 404 receive the requests for data and make requests to the disk array 406. A stealth controller 402 positioned between the storage controllers 404 and the disk array 406 may assist in processing requests to the disk array 406. For example, the stealth appliance 402 may decrypt requests and re-encrypt the requests with a community-of-interest key appropriate for a network containing the disk array 406. That is, the stealth controller 402 may perform similar to the stealth proxy 322 of FIG. 3. The stealth controller 402 may access the network through a switch 414 to reach the disk array 406. Also coupled to the switch 414 may be one or more additional disk arrays 426 and a remote site 428. The remote site 428 may include additional controllers, stealth appliances, switches, and/or disk arrays.

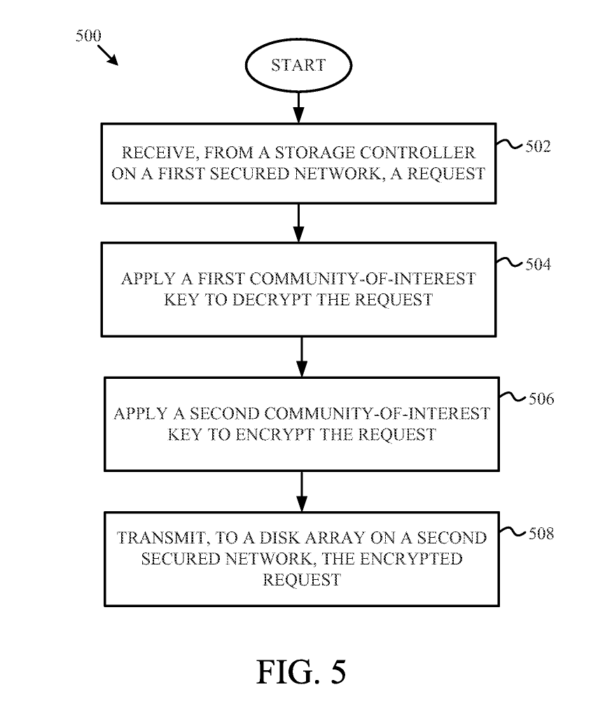

FIG. 5 is a flow chart illustrating a method of facilitating communication between a storage controller and a disk array located on different networks according to one embodiment of the disclosure. A method 500 begins at block 502 with receiving, from a storage controller on a first secured network, a request for data from a disk array. At block 504, a first community-of-interest (COI) key corresponding to the first secured network is applied to the request to decrypt the request. At block 506, a second community-of-interest (COI) key corresponding to a second secured network is applied to the decrypted request from block 504. The second COI key may be selected to match a COI the disk array has available. At block 508, the request encrypted with the second COI is transmitted to the disk array. Because the disk array is a member of the second COI, the disk array may decrypt the request and respond to the storage controller. The process for the disk array to communicate through the stealth appliance to the storage controller may be similar to that of method 500, including decrypting the data with the second COI key and encrypting the data with the first COI key.

The placement of a stealth appliance between the storage controllers and the disk array may promote or provide secured multi-tenancy virtual disks and direct or promote PCI DSS and HIPAA compliance. Furthermore, the stealth appliance for storage area networks may promote or provide vendor agnostic capabilities for operations support, COOP, snapshots, tiering, vplex, and storage virtualizations. The stealth appliance may provide access to storage area networks while being agnostic to the brand or type of storage solution on the network. Additionally, the storage stealth appliance may provide additional flexibility advantages to promote secured at rest storage to application servers, disaster recovery storage, and virtual tape library (VTL) enabled sites, including remote network locations.

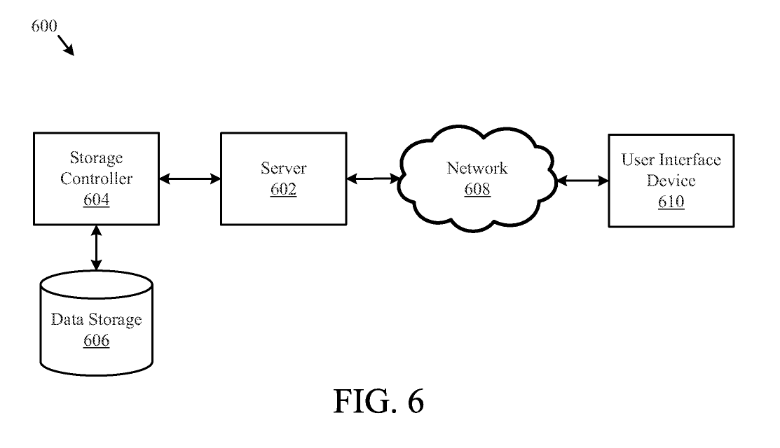

FIG. 6 illustrates one embodiment of a system 600 for an information system, which may host virtual machines. The system 600 may include a server 602, a data storage device 606, a network 608, and a user interface device 610. The server 602 may be a dedicated server or one server in a cloud computing system. The server 602 may also be a hypervisor-based system executing one or more guest partitions. The user interface device 610 may be, for example, a mobile device operated by a tenant administrator. In a further embodiment, the system 600 may include a storage controller 604, or storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other a mobile communication device having access to the network 608. The user interface device 610 may be used to access a web service executing on the server 602. In a further embodiment, the user interface device 610 may access the Internet or other wide area or local area network to access a web application or web service hosted by the server 602 and provide a user interface for enabling a user to enter or receive information.

The network 608 may facilitate communications of data, such as dynamic license request messages, between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 610 accesses the server 602 through an intermediate sever (not shown). For example, in a cloud application the user interface device 610 may access an application server. The application server may fulfill requests from the user interface device 610 by accessing a database management system (DBMS). In this embodiment, the user interface device 610 may be a computer or phone executing a Java application making requests to a MOSS server executing on a Linux server, which fulfills the requests by accessing a relational database management system (RDMS) on a mainframe server.

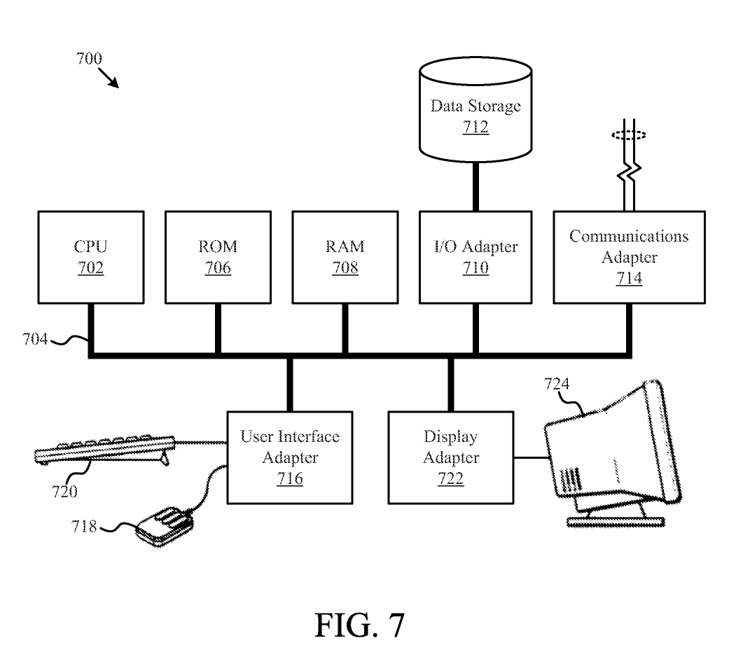

FIG. 7 illustrates a computer system 700 adapted according to certain embodiments of the server 702 and/or the user interface device 610. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 also may include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710, The communications adapter 714 may be adapted to couple the computer system 700 to the network 608, which may be one or more of a LAN, WAN, and/or the Internet. The communications adapter 714 may also be adapted to couple the computer system 700 to other networks such as a global positioning system (GPS) or a Bluetooth network. The user interface adapter 716 couples user input devices, such as a keyboard 720, a pointing device 718, and/or a touch screen (not shown) to the computer system 700. The keyboard 720 may be an on-screen keyboard displayed on a touch panel, The display adapter 722 may be driven by the CPU 702 to control the display on the display device 724, Any of the devices 702-722 may be physical and/or logical.

The applications of the present disclosure are not limited to the architecture of computer system 700. Rather the computer system 700 is provided as an example of one type of computing device that may be adapted to perform the functions of a server 602 and/or the user interface device 610. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. in fact, persons of ordinary skill in the art may utilize any number of suitable structures capable of executing logical operations according to the described embodiments. For example, the computer system 700 may be virtualized for access by multiple users and/or applications.

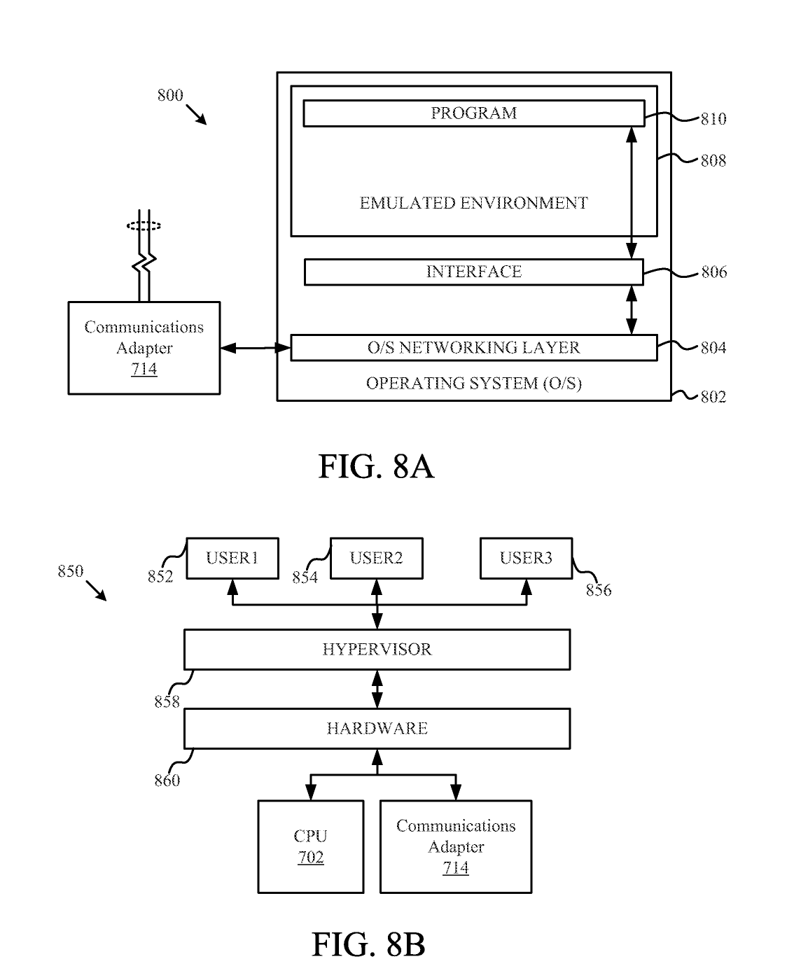

FIG. 8A is a block diagram illustrating a server hosting an emulated software environment for virtualization according to one embodiment of the disclosure. An operating system 802 executing on a server includes drivers for accessing hardware components, such as a networking layer 804 for accessing the communications adapter 714. The operating system 802 may be, for example, Linux. An emulated environment 808 in the operating system 802 executes a program 810, such as CPCommOS. The program 810 accesses the networking layer 804 of the operating system 802 through a non-emulated interface 806, such as XMOP. The non-emulated interface 806 translates requests from the program 810 executing in the emulated environment 808 for the networking layer 804 of the operating system 802.

In another example, hardware in a computer system may be virtualized through a hypervisor. FIG. 8B is a block diagram illustrating a server hosting an emulated hardware environment according to one embodiment of the disclosure. Users 852, 854, 856 may access the hardware 860 through a hypervisor 858. The hypervisor 858 may be integrated with the hardware 860 to provide virtualization of the hardware 860 without an operating system, such as in the configuration illustrated in FIG. 8A. The hypervisor 858 may provide access to the hardware 860, including the CPU 702 and the communications adaptor 714.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system, comprising:
a storage controller on a first secured network;
a disk array on a second secured network; and
a stealth appliance coupled to the storage controller and the disk array.

2. The system of claim 1, in which the stealth appliance is configured:
to receive a request from the storage controller encrypted with a first community-of-interest (COI) key;
to decrypt the request with the first COI key;
to encrypt the request with a second COI key; and
to transmit the encrypted request to the disk array.

3. The system of claim 2, in which the second COI key corresponds to the second secured network and the first COI key corresponds to the first secured network.

4. The system of claim 2, further comprising at least one of an application server and a file server, the server coupled to the storage controller through the first secured network.

5. The system of claim 2, further comprising a remote site coupled to the second secured network.

6. The system of claim 5, in which the remote site comprises a second storage controller, a second disk array, and a second stealth appliance coupled to the second storage controller and the second disk array.

7. The system of claim 2, in which the stealth appliance is further configured:
to receive data from the disk array encrypted with the second COI key;
to decrypt the data with the second COI key;
to encrypt the data with the first COI key; and
to transmit the encrypted data to the storage controller.

8. A method, comprising:
receiving, by a stealth appliance, a request from the storage controller encrypted with a first community-of-interest (COI) key;
decrypting, by the stealth appliance, the request with the first COI key;
encrypting, by the stealth appliance, the request with a second COI key; and
transmitting, by the stealth appliance, the encrypted request to the disk array.

9. The method of claim 8, further comprising:
receiving, by the stealth appliance, data from the disk array encrypted with the second COI key;
decrypting, by the stealth appliance, the data with the second COI key;
encrypting, by the stealth appliance, the data with the first COI key; and
transmitting, by the stealth appliance, the encrypted data to the storage controller.

10. The method of claim 8, in which the storage controller is coupled to a first secured network and the disk array is coupled to a second secured network and the stealth appliance is coupled to the first secured network and the second secured network.

11. The method of claim 10, in which the second COI key corresponds to the second secured. network and the first COI key corresponds to the first secured network.

12. The method of claim 8, in which the request is relayed from at least one of an application server and a file server, the server coupled to the storage controller through the first secured network.

13. An apparatus, comprising:
a memory;
a network interface; and
a processor coupled to the memory and to the network interface, in which the processor is configured:
to receive, through the network interface, a request from the storage controller encrypted with a first community-of-interest (COI) key;
to decrypt, by the processor, the request with the first COI key;
to encrypt, by the processor, the request with a second COI key; and
to transmit, through the network interface, the encrypted request to the disk array.

14. The apparatus of claim 13, in which the apparatus is a stealth appliance.

15. The apparatus of claim 14, in which the storage controller is coupled to a first secured. network and the disk array is coupled to a second secured network and the stealth appliance is coupled to the first secured network and the second secured network.

16. The apparatus of claim 15, in which the second COI key corresponds to the second secured network and the first COI key corresponds to the first secured network.

17. The apparatus of claim 13, in which the processor is further configured:
to receive, through the network interface, data from the disk array encrypted. with the second COI key;
to decrypt, by the processor, the data with the second COI key;
to encrypt, by the processor, the data with the first COI key; and
to transmit, through the network interface, the encrypted data. to the storage controller.

18. The apparatus of claim 13, in which the request is relayed from at least one of an application server and a file server, the server coupled to the storage controller through the first secured network.
